(19) United States
(12) Patent Application Publication
(10) Pub. No.: US 2005/0126721 A1
(43) Pub. Date: Jun. 16, 2005

(54) DOOR LEAF GUIDING ASSEMBLY OF A STACKING SYSTEM FOR LATERALLY FOLDING DOORS

(76) Inventor: Kenneth S. Fan, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/734,269

(22) Filed: Dec. 15, 2003

(51) Int. Cl. E05D 15/16

(52) U.S. Cl. 160/201

(57) ABSTRACT

A door leaf guiding assembly for a folding door includes two top guiding brackets, two stacking brackets and multiple roller assemblies. The folding door includes multiple door leaves that each has two opposite ends, and two side tracks that hold the ends of the door leaves. The top guiding brackets are respectively mounted on the side tracks and each has a slot to guide the door leaves onto the stacking brackets. The stacking brackets are respectively mounted on the top guiding brackets. The roller assemblies are respectively mounted on the ends of the door leaves and each includes a top and bottom roller assemblies that use conventional chain divisions that roll on the stacking brackets while the door leaves are arranged in a stack on the stacking brackets. Therefore, the roller assemblies are durable and of low manufacture cost.

### BACKGROUND OF THE INVENTION

1. Field of the Invention

The present invention relates to a door leaf guiding assembly of a stacking system for folding doors, and more particularly to a door leaf guiding assembly that uses multiple divisions of a chain to be a top roller and a bottom roller for a door leaf to move on a stacking bracket to arrange the door leaf in a stack, and the door leaf guiding assembly is durable and low cost.

2. Description of Related Art

Overhead folding doors are constructed of folding door leaves or panels and can be commonly found in residential garages. One kind of the overhead folding door comprises multiple door leaves that are partially overlapped sequentially to close the door and a stacking system to arrange the door leaves into a stack while the door is opened.

With reference to FIGS. 6 and 7, a conventional overhead folding door comprises an overhead frame (50), two side walls (51), two side tracks (A), multiple door leaves (80) and a stacking system (60). The overhead frame (50) has two sides (not numbered) and an inner space (not numbered). The side walls (51) are respectively attached to the sides of the overhead frame (50). The side tracks (A) respectively connect to the overhead frame (50) at the sides. The door leaves (80) are movably held in sequence in the side tracks (A) while the door is closed.

Each of the door leaves (80) has two opposite ends (not numbered), a top edge (not numbered) and a bottom edge (not numbered). The ends of the door leaves (80) are respectively held in the side tracks (A). The top edge is overlapped partially with the bottom edge of the adjacent door leaf (80). The door leaves (80) will be arranged in the inner space of the overhead frame (50) by the stacking system (60).

The stacking system (60) comprises a motor (64), a power transmission assembly (not numbered), two stacking brackets (not numbered) and a door leaf guiding assembly (not numbered). The motor (64) is mounted on the overhead frame (50) at one of the sides. The power transmission assembly connects to the motor (64) to transmit the outputting power of the motor (64) to lift the door leaves (80) and comprises two transmission mechanisms (not numbered) and a transmission shaft (63). The transmission mechanisms are respectively mounted at the sides of the overhead frame (50) and each comprises a driving chainwheel assembly (62), a driven chainwheel assembly (not numbered), a transmission chain (65) and a door leaf lifting chain (68). The transmission shaft (63) connects to both the transmission mechanisms so that they can work simultaneously.

The driving chainwheel assembly (62) is rotatably mounted on the side wall (51) and comprises a motor driven chainwheel (not numbered) and a driving chainwheel (not numbered). The chainwheels are connected concentrically to each other. The motor driven chainwheel is rotated by the motor (64) by means of a chain. The driving chainwheel connects to the driven chainwheel assembly with the transmission chain (65).

Likewise, the driven chainwheel assembly comprises a chain driven chainwheel (66) and a door leaf driving chainwheel (67). The chainwheels (66,67) are connected concentrically to each other. The chain driven chainwheel (66) connects to the driving chainwheel with the transmission chain (65) and is rotated by the driving chainwheel. The door leaf lifting chain (68) meshes with the door leaf driving chainwheel (67) of the driven chainwheel assembly and has a stationary end (not numbered) and a movable end (not numbered). The stationary end is fastened on the stacking bracket. The movable end extends into one of the side tracks (A) to lift the door leaves (80).

With reference to FIGS. 7 and 8, the door leaf guiding assembly comprises two top guiding brackets (73) and multiple roller assemblies (not numbered). The top guiding brackets (73) are respectively mounted on the side tracks (A) and each has a slot (72). The slot (72) has a bottom opening (not numbered) and a top opening (not numbered). The bottom opening faces one of the side tracks (A).

The roller assemblies are respectively mounted at the ends of the door leaves (80) and each comprises a top roller bracket (not numbered), a top roller (81), a bottom roller bracket (84), a bottom roller (83) and a chain roller (82). The top roller bracket is mounted on the end of the door leaf (80) adjacent to the top edge and fastened pivotally to one link of the door leaf lifting chain (68). The top roller (81) is rotatably mounted on the top roller bracket. The bottom roller bracket (84) is mounted on the end of the door leaf (80) adjacent to the bottom edge. The bottom roller (83) and the chain roller (82) are rotatably mounted on the bottom roller bracket (84), where the bottom roller (83) is between the chain roller (82) and the end of the door leaf (80). The chain roller (83) rotatably abuts on the door leaf lifting chain (68) to smooth the door leaf lifting chain (68) during operation.

The stacking brackets are respectively mounted in the overhead frame (50) adjacent to the side walls (51) and each comprises a top roller rail (70) and a bottom roller rail (71). The top and the bottom roller rails (70, 71) are fastened on the top guiding bracket (73), have respectively a top edge (not numbered) and are parallel to each other. The top edge of the bottom roller rail (71) is sited under the top opening of the slot (72).

When the door leaf lifting chains (68) of the two transmission mechanisms are moved upward, the door leaves (80) will be moved simultaneously upward. The bottom rollers (83) of the top one of the door leaves (80) will be guided into the slots (72). The slots (72) guide the door leaf (80) to move into the inner space of the overhead frame (50) between the top and the bottom roller rails (70, 71). The top and the bottom rollers (81, 83) respectively roll on the top edges of the top and the bottom roller rails (70, 71). To continuously operate the door leaf lifting chains (68) will repeatedly move each of the door leaves (80) and arrange the door leaves (80) in a stack on the top and the bottom roller rails (70, 71).

However, the top and the bottom rollers (81, 83) and the chain roller (82) in accordance with prior art are made of plastic. The plastic rollers (81, 82, 83) are not durable and after a long-term and repeated use, the plastic rollers (81, 82, 83) will be easily damaged and worn. If metal rollers are used to replace the plastic rollers (81, 82, 83), additional cost is incurred in fabricating the metal rollers.

To overcome the shortcomings, the present invention provides an improved door leaf guiding assembly of a stacking system to mitigate or obviate the aforementioned problems.

### SUMMARY OF THE INVENTION

The main objective of the invention is to provide a door leaf guiding assembly of a stacking system for a folding door, and the door leaf guiding assembly is durable and low in cost.

To achieve the aforesaid objective, a door leaf guiding assembly of a stacking system for a folding door includes two top guiding brackets, two stacking brackets and multiple roller assemblies. The folding door includes multiple door leaves each having two opposite ends, and two side tracks movably hold the ends of the door leaves. The top guiding brackets are respectively mounted on the side tracks and each has a slot to guide the door leaves onto the stacking brackets. The stacking brackets are respectively mounted on the top guiding brackets. The roller assemblies are respectively mounted on the ends of the door leaves and each includes a top roller and bottom roller assembly that uses conventional chain divisions to let the door leaves roll on the stacking brackets as the door leaves are arranged in a stack on the stacking brackets. Therefore, the roller assemblies are durable and incur a low manufacture cost for the roller assemblies.

Other objectives, advantages and novel features of the invention will become more apparent from the following detailed description when taken in conjunction with the accompanying drawings.

### BRIEF DESCRIPTION OF THE DRAWINGS

FIG. 1 is a plan view of a stacking system uses a door leaf guiding assembly in accordance with the present invention;

FIG. 2 is a perspective view of a segment of the stacking system in FIG. 1;

FIG. 3 is an exploded perspective view of a roller assembly in accordance with the present invention;

FIG. 4 is a perspective view of the roller assembly in FIG. 3;

FIG. 5 is an operational side plan view of the stacking system when a side wall is removed from an overhead frame;

FIG. 6 is a perspective view of a folding door in accordance with the prior art;

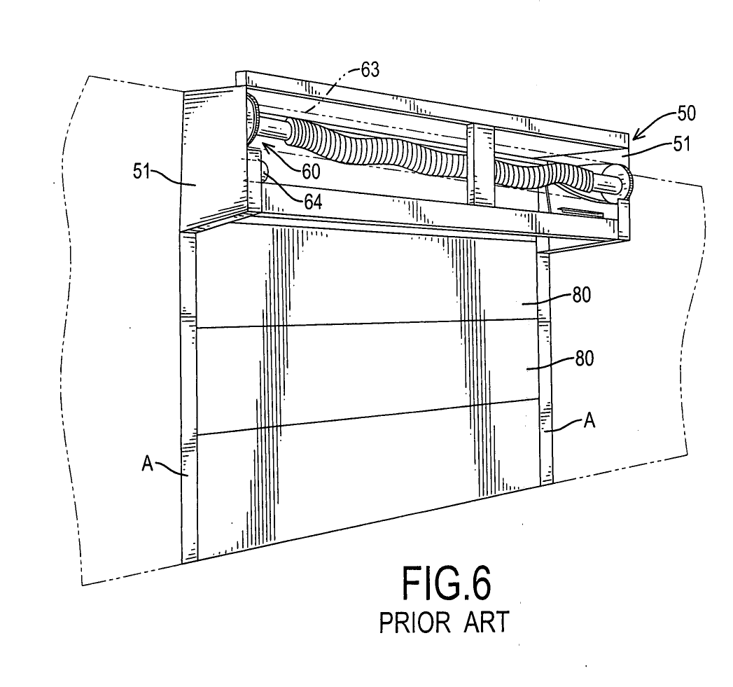

FIG. 7 is a side plan view of a stacking system in accordance with the prior art; and

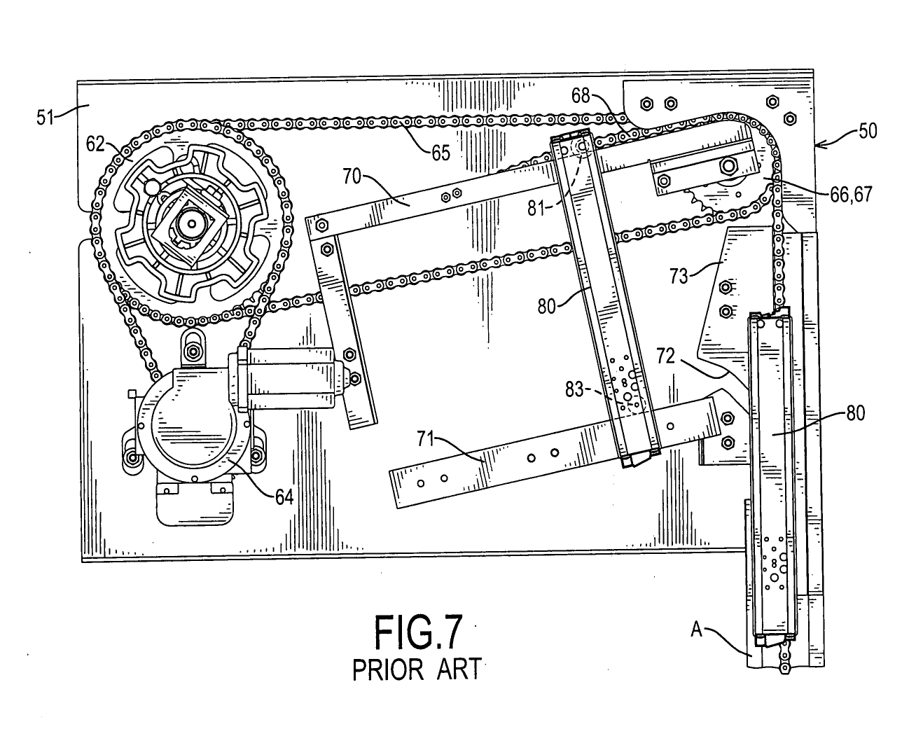

FIG. 8 is a plan view of a roller assembly in accordance with the prior art.

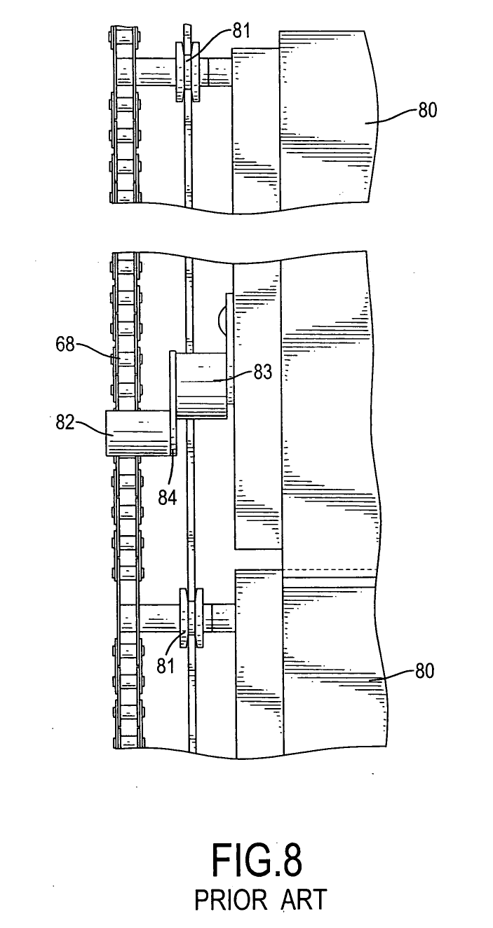

### DETAILED DESCRIPTION OF PREFERRED EMBODIMENT

An embodiment in accordance with the present invention is a modification of the door leaf guiding assembly described previously in the description of related art. A door leaf guiding assembly in accordance with the present invention is constructed in a conventional overhead folding door described previously in the description of related art.

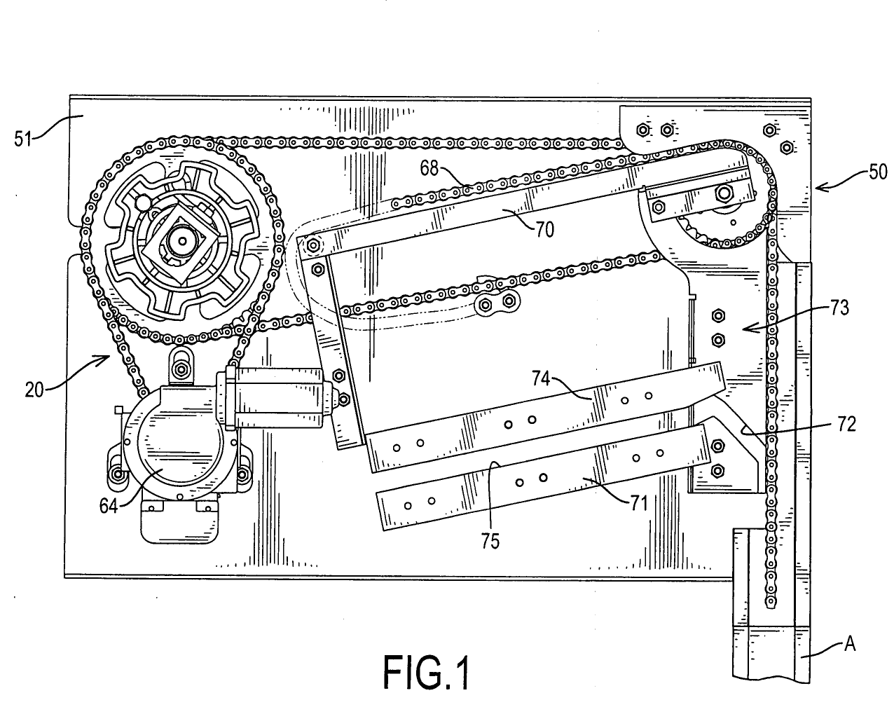

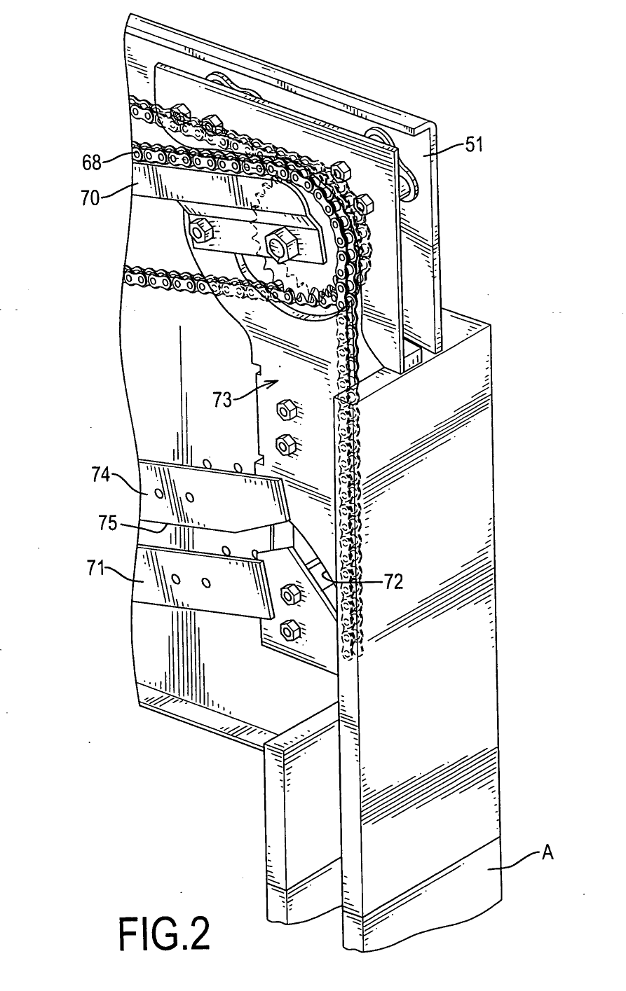

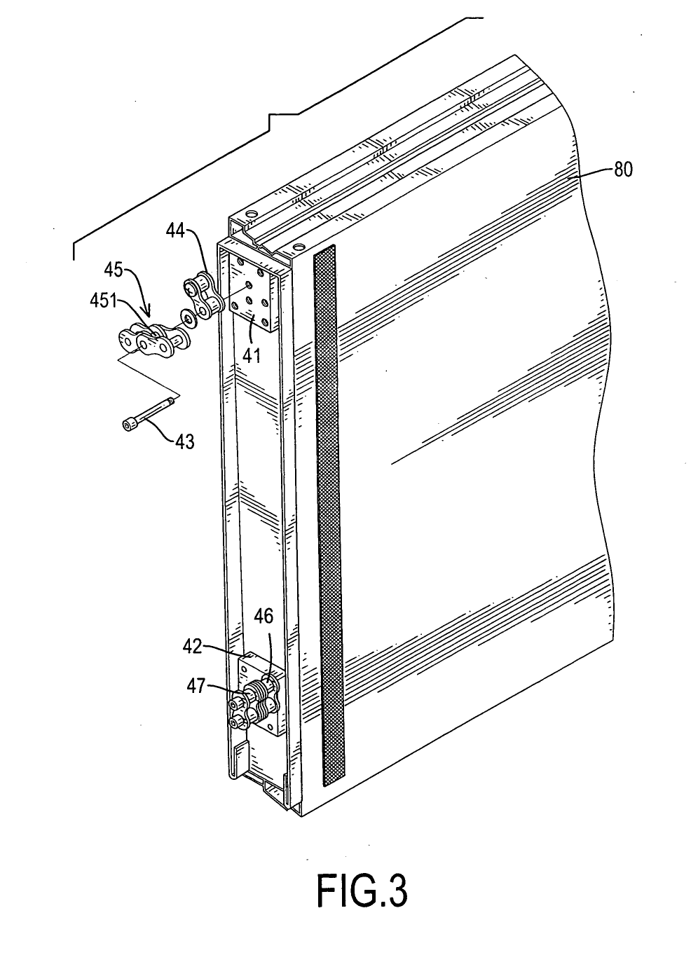

With reference to FIGS. 1, 2 and 3, the overhead folding door comprises an overhead frame (50) with two side walls (51), two side tracks (A), multiple door leaves (80) and a stacking system (20) as previously described. Each of the door leaves (80) has a top edge (not numbered), a bottom edge (not numbered) and two opposite ends (not numbered). The stacking system (20) comprises a motor (64), a power transmission assembly (not numbered), two stacking brackets (not numbered) and a door leaf guiding assembly (not numbered). The power transmission assembly has a door leaf lifting chain (68). The door leaf lifting chain (68) is constructed in a conventional manner. The overhead frame (50), the two side walls (51), two side tracks (A), the door leaves (80), the motor (64) and the power transmission assembly are constructed in a conventional manner, therefore, a detailed description is not provided further.

The door leaf guiding assembly in accordance with the present invention comprises two conventional top guiding brackets (73) and multiple roller assemblies (not numbered). The top guiding brackets (73) are respectively mounted on the side tracks (A) and each has a slot (72). The slot (72) has a bottom opening (not numbered) and a top opening (not numbered). The bottom opening faces one of the side tracks (A).

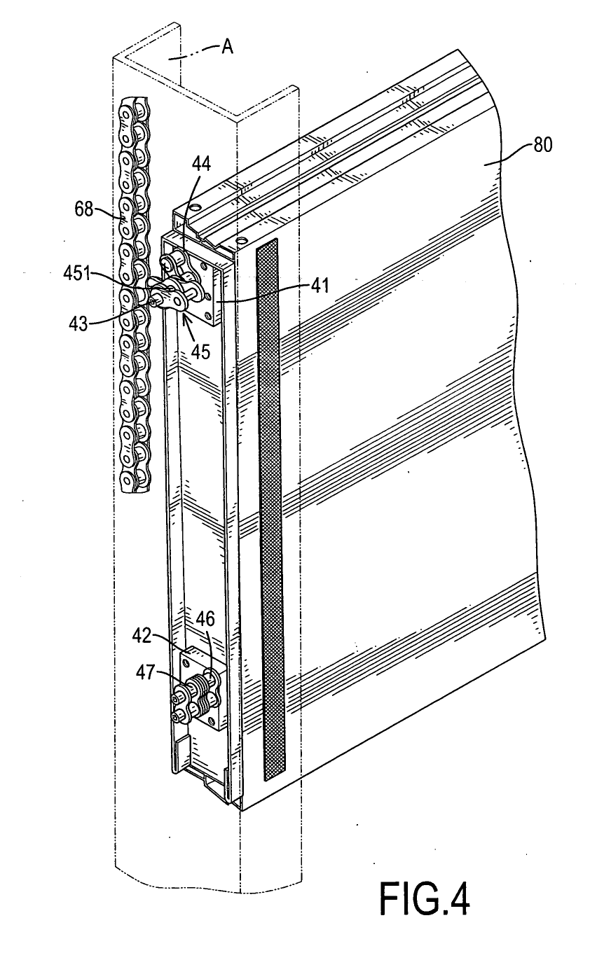

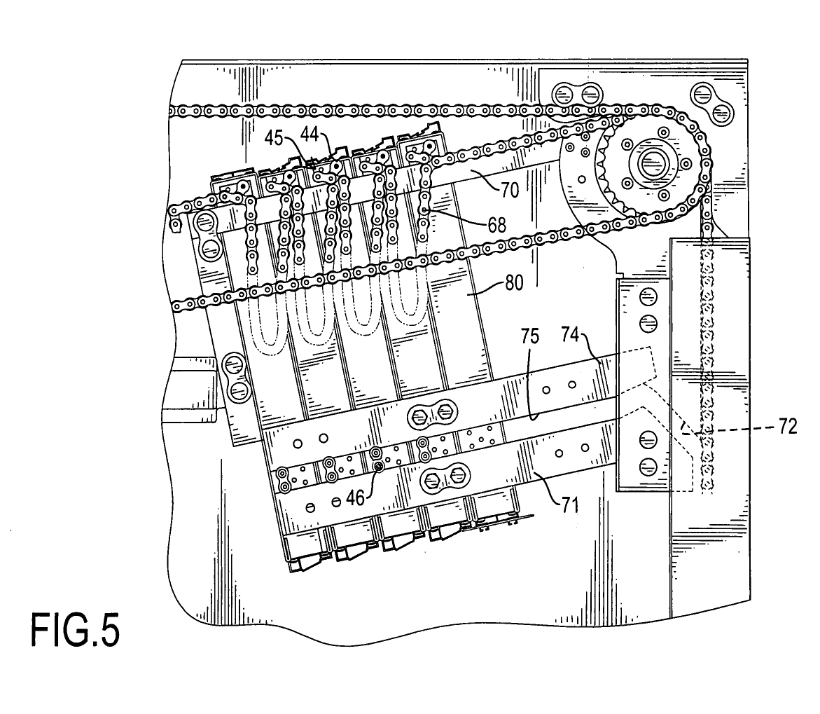

With reference to FIGS. 4 and 5, the roller assembly in accordance with the present invention is mounted at the end of the door leaf (80) and comprises a top roller assembly (not numbered) and a bottom roller assembly (not numbered). The top roller assembly comprises a top mounting bracket (41), a top chain link (44), a connecting chain link (45) and a fastener (43), such as a bolt. The top mounting bracket (41) is mounted on the end of the door leaf (80) and has a side (not numbered). The top chain link (44) is attached to the side of the top mounting bracket (41) and may be a division of a roller chain. The connecting chain link (45) is stacked on the top chain link (44) and comprises two divisions of a chain, such as a roller chain. The divisions of the connecting chain link (45) pivotally connect to each other at a joint (451). One of the divisions of the connecting chain link (45) pivotally connects to the door leaf lifting chain (68). The fastener (43) passes through the joint (451) of the connecting chain link (45), extends into the top chain link (44) and fastens on the top mounting bracket (41).

The bottom roller assembly comprises a bottom mounting bracket (42), an inside chain link (46) and an outside chain link (47). The bottom mounting bracket (42) is mounted on the end of the door leaf (80) and has a side (not numbered). The inside chain link (46) and the outside chain link (47) are two separated divisions of a chain, such as a roller chain. The inside chain link (46) is g mounted on the side of the bottom mounting bracket (42). The outside chain link (47) is attached on the inside chain link (46) and is arranged with the inside chain link (46) in a stack.

The stacking brackets in accordance with the present invention are respectively mounted in the overhead frame (50) adjacent to the side walls (51) and each comprises a conventional top roller rail (70), a conventional bottom roller rail (71) and an auxiliary bottom roller rail (74). The top and the bottom roller rails (70, 71) are respectively mounted on the top guiding bracket (73), have respectively a top edge (not numbered) and are parallel to each other. The auxiliary bottom roller rail (74) is mounted on the top guiding bracket (73) between the top and the bottom roller rails (70, 71) and has a bottom edge (not numbered). The bottom edge of the auxiliary bottom roller rail (74) is parallel to the top edge of the bottom roller rail (71), and forms a channel (75) communicated with the top opening of the slot (72).

Therefore, when the door leaf lifting chains (68) of the two transmission mechanisms are moved upward, the door leaves (80) will be moved simultaneously upward. The individual inside chain link (46) on the top one of the door leaves (80) will be guided to move into the slot (72). The slot (72) guides the inside chain link (46) to move into the channel (75) so that the door leaf (80) will move into the inner space of the overhead frame (50) on the top and the bottom roller rails (70, 71). The top and the inside chain links (44,46) respectively roll or slide on the top edges of the top and the bottom roller rails (70, 71). To continuously operate the door leaf lifting chains (68) will repeatedly move the door leaves (80) and arrange the door leaves (80) in a stack on the top and the bottom roller rails (70, 71).

Since the top chain link (44), the connecting chain link (45), the inside chain link (46) and the outside chain link (47) are divisions of a conventional chain, each of them is simple and cheap to manufacture. Also, to connect the chain links (44, 45, 46, 47) to the door leaf lifting chain (68) or one by another is easy. Therefore, the door leaf guiding assembly is durable and of low cost.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A door leaf guiding assembly of a stacking system for a folding door having multiple door leaves each having a top edge, a bottom edge and two opposite ends, two side tracks holding the ends of the door leaves and a door leaf lifting chain extending into each one of the side tracks to lift the door leaves, and the door leaf guiding assembly comprising:
a top guiding bracket adapted to be mounted on each respective one of the side tracks and having a slot with a top opening and a bottom opening to face the respective one of the side tracks;
a roller assembly adapted to be mounted on each end of each respective one of the door leaves and comprising
a top roller assembly comprising
a top mounting bracket having a side;
a top chain link attached to the side of the top mounting bracket;
a connecting chain link mounted on the top chain link and comprising two divisions of a chain, the chain divisions of the connecting chain link pivotally connected to each other at a joint, and one of the chain divisions adapted to be pivotally connected to the door leaf lifting chain; and
a fastener passing through the joint of the connecting chain link, extending into the top chain link and fastened on the top mounting bracket; and
a bottom roller assembly comprising
a bottom mounting bracket having a side;
an inside chain link being a chain division and mounted on the side of the bottom mounting bracket; and
an outside chain link being a chain division, attached on the inside chain link and arranged with the inside chain link in a stack; and
a stacking bracket mounted on the top guiding bracket and comprising
a top roller rail mounted on the top guiding bracket and having a top edge; and
a bottom roller rail mounted on the top guiding bracket under the top opening of the slot and having a top edge parallel to the top edge of the top roller rail;
wherein the top chain link and the inside chain link respectively abut and move on the top edges of the top and the bottom roller rails as the door leaves are arranged in a stack on the stacking bracket.

2. The door leaf guiding assembly of a stacking system for a folding door as claimed in claim 1, wherein the stacking bracket further comprises an auxiliary bottom roller rail mounted on the top guiding bracket between the top and the bottom roller rails, the auxiliary bottom roller has a bottom edge and the bottom edge of the auxiliary bottom roller rail is parallel to the top edge of the bottom roller rail, forms a channel communicated with the top opening of the slot.

3. The door leaf guiding assembly of a stacking system for a folding door as claimed in claim 2, wherein each of the top chain link, the inside chain link and the outside chain link is a division of a roller chain, and the connecting chain link has two divisions of a roller chain.
